(19) United States
(12) Patent Application Publication
(10) Pub. No.: US 2011/0263300 A1
(43) Pub. Date: Oct. 27, 2011

(54) PORTABLE TERMINAL

(75) Inventors: Mitsuhiro Nishizono, Yokohama-shi (JP); Yasuhiro Abe, Yokohama-shi (JP)

(73) Assignee: KYOCERA CORPORATION, Kyoto-shi (JP)

(21) Appl. No.: 13/141,824

(22) PCT Filed: Dec. 25, 2009
(86) PCT No.: PCT/JP2009/007309

§ 371 Date: Jun. 23, 2011

(30) Foreign Application Priority Data
Dec. 25, 2008 (JP) 2008-329974
Dec. 25, 2008 (JP) 2008-330346
May 27, 2009 (JP) 2009-127489
Jul. 29, 2009 (JP) 2009-177120

(51) Int. Cl. H04W 52/00; H04W 4/00

(52) U.S. Cl. 455/566; 455/572

(57) ABSTRACT

Disclosed is a portable terminal that can improve antenna characteristics regardless of the opened or closed state of a case. A portable terminal (1) comprises a first case (2) and a second case (3), a opening/closing sensor (45), which is able to detect an open state and a closed state, a circuit (32), comprising a ground (35), a power supply (36), and a signal processor (37), a first conductor (31), which is disposed in the first case (2) and connected to the ground (35), and a second conductor (400), which is disposed in the second case (3) and connected to the power supply (36), wherein the second conductor (400) is configured having a first part (41) and second part (42), which are adjacently disposed in the alignment direction of the first conductor (31) and second conductor (400) in the open state, and is further equipped with a controller (44) which, when the closed state is detected, provides high-frequency shielding of the second part (42) from the first part (41) and, when the open state is detected, provides high-frequency coupling between the first part (41) and second part (42).

### TECHNICAL FIELD

The present invention relates to a mobile terminal device such as a cellular telephone device.

### BACKGROUND ART

As a mobile terminal device, a cellular telephone device of a folder type has been known, which includes a first body, a second body, and a connecting portion connecting the first body and the second body, and which is configured so as to be capable of transitioning to an opened state and a closed state via the connecting portion depending on the usage aspects. A cellular telephone device of such a folder type has a communication function to perform communication externally via an antenna.

As an antenna used for a cellular telephone device, for example, Patent Document 1 proposes a technique, in which one of a first conductive portion disposed in the first body and a second conductive portion disposed in the second body is utilized as an antenna, by feeding power to one of the first conductive portion and the second conductive portion and by grounding the other one (in a ground state).
Patent Document 1: Japanese Unexamined Patent Application, Publication No. 2002-335180

### DISCLOSURE OF THE INVENTION

### Problems to be Solved by the Invention

However, in the technique proposed in Patent Document 1, although satisfactory antenna characteristics are provided in the opened state of the cellular telephone device, there has been a problem in the closed state where the high-frequency current transmission direction in the first conductive portion is opposite to the high-frequency current transmission direction in the second conductive portion, and thus the high-frequency currents thereof are cancelled by each other, deteriorating the antenna characteristics.

Therefore, an object of the present invention is to provide a mobile terminal device, in which the deterioration of the antenna characteristics can be suppressed regardless of the opened state and the closed state of the bodies.

### Means for Solving the Problems

The present invention relates to a mobile terminal device, including a first body and a second body that are connected to be capable of transitioning between an opened state and a closed state; a detecting unit that is configured to detect the opened state and the closed state; a circuit unit that is disposed in one of the first body or the second body, and includes a ground unit, a power feed unit, and a signal processing unit connected to the ground unit and the power feed unit; a first conductive portion that is disposed in the first body, and is connected to one of the ground unit or the power feed unit of the circuit unit; a second conductive portion that is disposed in the second body, is connected to the other one of the ground unit or the power feed unit of the circuit unit, and includes a first portion and a second portion that are disposed adjacently to each other in an alignment direction of the first conductive portion and the second conductive portion in the opened state; and a control unit that cuts off the second portion from the first portion at high frequency in a case in which the detecting unit detects the closed state, and couples the first portion and the second portion at high frequency in a case in which the detecting unit detects the opened state.

Moreover, it is preferable that the control unit cuts off the second portion from the first portion at high frequency, or connects the first portion and the second portion at high frequency, such that a high-frequency transmission path length in the first portion in the closed state is different from a high-frequency transmission path length in the first portion and the second portion in the opened state.

In addition, it is preferable that the mobile terminal device further includes a display unit that is exposed to an outside in the opened state, and is concealed by the first body or the second body in the closed state, in which the high-frequency transmission path length in the first portion is a length corresponding to a high-frequency frequency band that is used for exercising a communication function that does not use the display unit, and the high-frequency transmission path length in the first portion and the second portion is a length corresponding to a high-frequency frequency band that is used for exercising a communication function that uses the display unit.

Furthermore, it is preferable that, in a case in which a predetermined function is being executed in the closed state by using a high frequency transmitted to the first portion, the control unit connects the first portion and the second portion when the opened state is detected by the detecting unit and an operation of the predetermined function is suppressed.

Moreover, it is preferable that, in a case in which a predetermined function is being executed in the opened state by using a high frequency transmitted to the first portion and the second portion, the control unit cuts off the first portion and the second portion when the closed state is detected by the detecting unit and an operation of the predetermined function is suppressed in the closed state.

In addition, it is preferable that slits are formed in the first portion, and a high-frequency transmission path length formed by the slits in the first portion is substantially identical to a length of the first conductive portion in the alignment direction.

The present invention relates to a mobile terminal device, including a first body and a second body that are connected to be capable of transitioning between an opened state and a closed state; a circuit unit that is disposed in one of the first body or the second body, and includes a ground unit, a power feed unit, and a signal processing unit connected to the ground unit and the power feed unit; a first conductive portion that is provided in the first body, and is connected to the ground unit of the circuit unit; and a second conductive portion that is provided in the second body, is capacitively coupled to the first conductive portion, and is connected to the power feed unit of the circuit unit.

Moreover, it is preferable that the mobile terminal device further includes a capacitive coupling portion that is disposed in at least one of the first body and the second body, and the capacitive coupling portion capacitively couples the first conductive portion and the second conductive portion in the closed state.

In addition, it is preferable that the capacitive coupling portion is configured to include an inductive member having inductivity.

Furthermore, it is preferable that at least one of the first conductive portion and the second conductive portion is a circuit board on which an electronic component is mounted, and the capacitive coupling portion is the electronic component.

Moreover, it is preferable that the second conductive portion includes: a first portion; a second portion; and a first selection unit that selects one of a first state in which the first portion and the second portion are connected, and a second state in which the first portion and the second portion are separated.

In addition, it is preferable that the second conductive portion includes a first portion and a second portion that are separated at high frequency, and the mobile terminal device further includes a second selection unit that selects one of a first connection state in which the first portion and the power feed unit are connected, and a second connection state in which the second portion and the power feed unit are connected.

Furthermore, it is preferable that the circuit unit further includes an adjustment unit that is electrically connected to the signal processing unit, and in a case in which the first body and the second body move into the closed state and the first conductive portion and the second conductive portion are capacitively coupled, the adjustment unit performs adjustment of reactance including electrostatic capacity arising between the first conductive portion and the second conductive portion.

Moreover, it is preferable that the adjustment unit further includes a third selection unit for selectively performing the adjustment of reactance.

### EFFECTS OF THE INVENTION

According to the mobile terminal device of the present invention, the deterioration of the antenna characteristics can be suppressed regardless of the opened state and the closed state of the bodies.

### BRIEF DESCRIPTION OF THE DRAWINGS

FIG. 1 is a perspective view showing an appearance of a cellular telephone device according to a first embodiment of the present invention;

FIG. 2 is a front view schematically showing a state in which an operation unit side body and a display unit side body are opened;

FIG. 3 is a lateral view schematically showing a state in which the operation unit side body and the display unit side body are closed;

FIG. 4 is a block diagram showing a configuration of control of the cellular telephone device;

FIG. 5 is a diagram showing a flow of a high-frequency current in the state in which the operation unit side body and the display unit side body are opened;

FIG. 6 is a diagram showing a flow of the high-frequency current in the state in which the operation unit side body and the display unit side body are closed;

FIG. 7 is a diagram showing a first portion in a second embodiment of the present invention;

FIG. 8 is a front view schematically showing a state in which an operation unit side body and a display unit side body of a cellular telephone device of a third embodiment are opened;

FIG. 9 is a lateral view schematically showing a state in which the operation unit side body and the display unit side body of the cellular telephone device of the third embodiment are closed;

FIG. 10 is a cross-sectional view showing surroundings of a first capacitive coupling portion;

FIG. 11 is a perspective view showing another example of the capacitive coupling portion;

FIG. 12 is a front view schematically showing a state in which an operation unit side body and a display unit side body of a cellular telephone device of a fourth embodiment are opened;

FIG. 13 is a lateral view schematically showing a state in which the operation unit side body and the display unit side body of the cellular telephone device of the fourth embodiment are closed;

FIG. 14 is a cross-sectional view schematically showing a configuration of a vicinity of the first capacitive coupling portion and the second capacitive coupling portion;

FIG. 15 is a front view schematically showing an inside of a cellular telephone device of a fifth embodiment in the opened state;

FIG. 16 is a lateral view schematically showing the inside of the cellular telephone device of the fifth embodiment in the closed state; and

FIG. 17 is a diagram showing an equivalent circuit regarding the first capacitive coupling portion, the second capacitive coupling portion and an adjustment unit.

### PREFERRED MODE FOR CARRYING OUT THE INVENTION

### First Embodiment

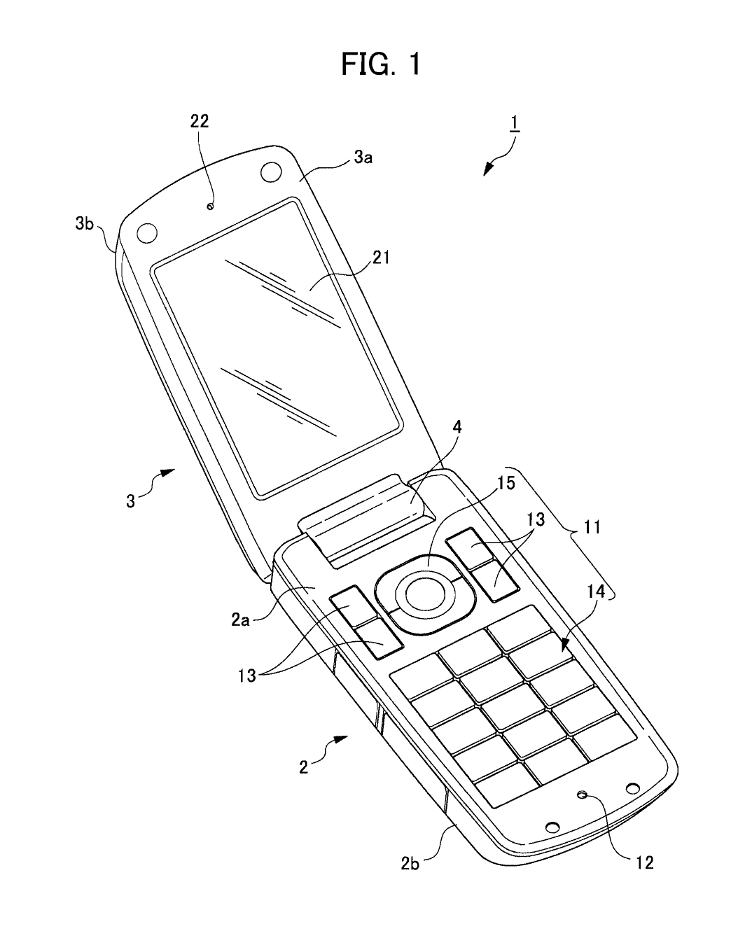

A preferred embodiment for carrying out the present invention is hereinafter described with reference to the drawings. A basic structure of a cellular telephone device 1 as a mobile terminal device according to a first preferable embodiment of the present invention is described with reference to FIG. 1. FIG. 1 is a perspective view showing an appearance of the cellular telephone device 1 in an opened state.

As shown in FIG. 1, the cellular telephone device 1 includes: an operation unit side body 2 as a first body; and a display unit side body 3 as a second body. The operation unit side body 2 and the display unit side body 3 are connected so as to be openable and closable via a connecting portion 4 including a hinge mechanism. More specifically, an upper end portion of the operation unit side body 2 and a lower end portion of the display unit side body 3 are connected via the connecting portion 4. As a result, the cellular telephone device 1 is configured so as to be capable of forming opened/closed states by relatively moving the operation unit side body 2 and the display unit side body 3 connected via the hinge mechanism. In other words, the cellular telephone device 1 can be arranged into an opened state where the operation unit side body 2 and the display unit side body 3 are apart from each other, and into a folded state where the operation unit side body 2 and the display unit side body 3 are contacting each other, by relatively rotating (pivoting) the operation unit side body 2 and the display unit side body 3, which are connected via the connecting portion 4.

An outer surface of the operation unit side body 2 is configured with a front case 2a and a rear case 2b. The operation unit side body 2 is configured to expose, on the front case 2a side, an operation key set 11 and a microphone 12 as a sound input unit to which sound produced by a user of the cellular telephone device 1 during a phone call is input.

The operation key set 11 has: function setting operation keys 13 for operating various functions such as for various settings, a telephone number directory function and a mail function; input operation keys 14 for inputting the digits of a telephone number, characters for mail, and the like; and a selection operation key 15 for performing selection of the various operations, scrolling up, down, left and right, etc. Predetermined functions are assigned (key assignment) to each key configuring the operation key set 11 in accordance with the opened/closed state of the operation unit side body 2 and the display unit side body 3, various modes, and the type of application that is running. An operation corresponding to a function assigned to each key is executed by the user depressing each key.

The microphone 12 is disposed to an outer end side (lower end side) that is opposite to the connecting portion 4 side in a longitudinal direction of the operation unit side body 2. In other words, the microphone 12 is disposed to one outer end side of the cellular telephone device 1 in the opened state.

An interface (not illustrated) for communicating with an external device (for example, a host device) is disposed on one side face of the operation unit side body 2. Side keys, to which predetermined functions are assigned, and an interface (not illustrated) where external memory is inserted and removed are disposed on another side face of the operation unit side body 2. Each interface is covered with a cap. When not in use, each interface is covered with a cap.

An outer surface of the display unit side body 3 is configured with a front case 3a and a rear case 3b. On the front case 3a of the display unit side body 3, a display unit 21 for displaying a variety of information, and a sound output unit 22 as a receiver that outputs sound of the other party of a phone call are disposed so as to be exposed to the outside. Here, the display unit 21 is configured with a liquid crystal display panel, a drive circuit that drives the liquid crystal display panel, a light source unit such as a backlight that irradiates light from the back face side of the liquid crystal display panel, etc.

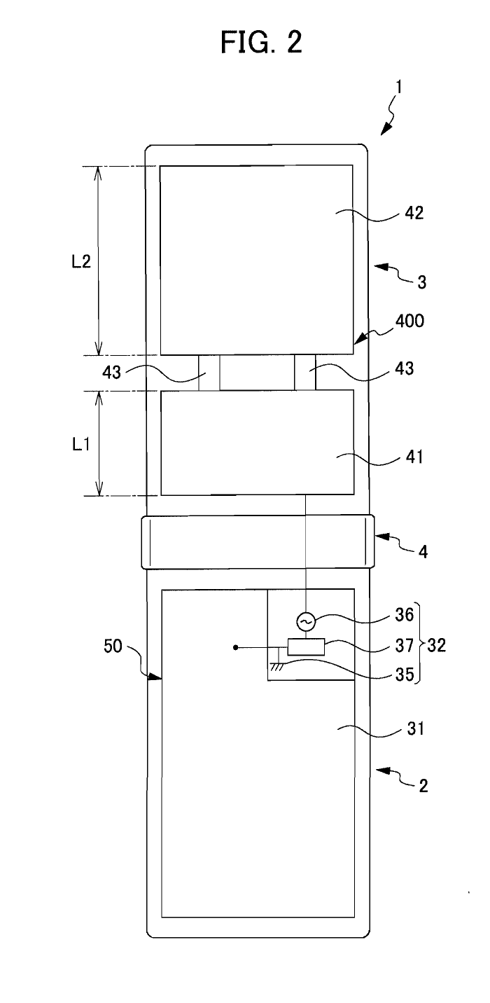

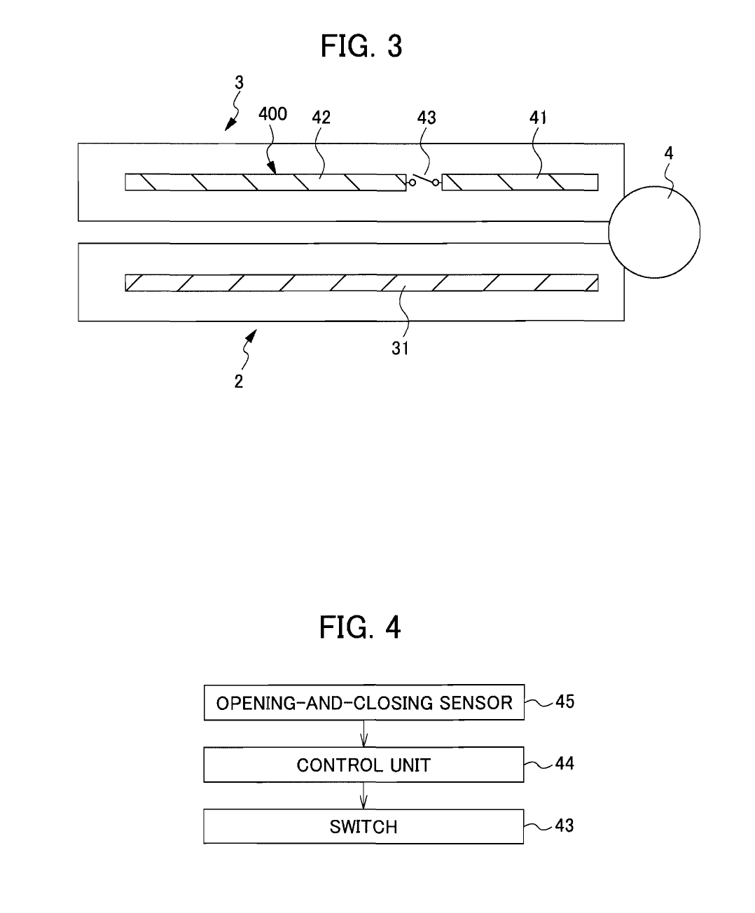

Next, internal structures of the operation unit side body 2 and the display unit side body 3 are described with reference to FIGS. 2 and 3. FIG. 2 is a front view schematically showing the inside of the cellular telephone device 1 in the opened state. FIG. 3 is a lateral view schematically showing the inside of the cellular telephone device 1 in the closed state. It should be noted that, in FIGS. 2 and 3, only a first conductive portion 31, a circuit unit 32 and the like are virtually shown with regard to components in the operation unit side body 2, and only a second conductive portion 400 and the like are virtually shown with regard to components in the display unit side body 3.

As shown in FIGS. 2 and 3, the operation unit side body 2 includes the first conductive portion 31 and the circuit unit 32, within the inside thereof, more specifically between the front case 2a and the rear case 2b. In the first embodiment, the first conductive portion 31 and the circuit unit 32 are each configured with a part of a circuit board 50.

The first conductive portion 31 is configured with a ground pattern formed on the area of the circuit board 50 excluding the circuit unit 32. The circuit unit 32 includes a ground unit 35, a power feed unit 36, and a signal processing unit 37 that is connected to the ground unit 35 and the power feed unit 36. The ground unit 35 is connected to the first conductive portion 31. The power feed unit 36 is connected at high frequency to the second conductive portion 400 disposed in the display unit side body 3, and feeds power to the second conductive portion 400. More specifically, the power feed unit 36 is connected to a first portion 41 that is positioned on the connecting portion 4 side in the second conductive portion 400, which will be described later. The signal processing unit 37 is configured with: a radio circuit including an RF circuit; a matching circuit; a control circuit; and the like. In the signal processing unit 37, predetermined processing is performed on a signal fed from the power feed unit 36.

As shown in FIGS. 2 and 3, the display unit side body 3 is connected to the operation unit side body 2 via the connecting portion 4, such that a state of being superimposed with the operation unit side body 2 can be formed. The display unit side body 3 includes the second conductive portion 400 within the inside thereof, more specifically between the front case 3a and the rear case 3b. The second conductive portion 400 includes the first portion 41, a second portion 42, and a switch 43 as switching means provided therebetween.

The first portion 41 and the second portion 42 are disposed adjacently to each other along an alignment direction of the first conductive portion 31 and the second conductive portion 400 in the state in which the operation unit side body 2 and the display unit side body 3 are opened. More specifically, the first portion 41 is disposed on the connecting portion 4 side (bottom side in FIG. 2), and the second portion 42 is disposed in an adjacent position that is apart from the connecting portion 4. Both of the first portion 41 and the second portion 42 are formed of a conductive material. The first portion 41 is configured with, for example, a circuit board, and the second portion 42 is configured with, for example, a shielding case. In the first embodiment, a length L1 of the first portion 41 (a length along the alignment direction of the bodies 2 and 3 in the opened state of the bodies 2 and 3) is configured to be no more than half a length L2 of the second portion 42.

The switch 43 connects or cuts off the first portion 41 and the second portion 42 at high frequency. More specifically, the switch 43 mechanically connects and cuts off the first portion 41 and the second portion 42, by way of a movable contact moving between fixed contacts that are provided to the first portion 41 side and the second portion 42 side, respectively. The switch 43 is disposed in two positions between the first portion 41 and the second portion 42, and each switch 43 connects the first portion 41 and the second portion 42. The connecting and cutting off of the first portion 41 and the second portion 42 at high frequency by the switch 43 are controlled by a control unit 44 that will be described later (see FIG. 4).

Next, control of the switch 43 by the control unit 44 is described with reference to FIG. 4. FIG. 4 is a functional block diagram of the cellular telephone device 1, illustrating control of the switch 43 by the control unit 44. As a configuration for switching the switch 43 in accordance with the opened state and the closed state, the cellular telephone device 1 includes an opening-and-closing sensor 45 as a detecting unit, the control unit 44, and the switch 43.

The opening-and-closing sensor 45 detects the opened state and the closed state of the cellular telephone device 1. The opening-and-closing sensor 45 is configured with a magnet disposed in the operation unit side body 2 and a hall element disposed in the display unit side body 3 (none of which are illustrated), and detects the opened state and the closed state of the cellular telephone device 1. More specifically, the opening-and-closing sensor 45 detects magnetic intensity arising from the difference of the positional relationship of the operation unit side body 2 and the display unit side body 3, and determines whether the cellular telephone device 1 is in the opened state or the closed state, based on a detected result.

The control unit 44 controls the switch 43 in accordance with the opened state and the closed state of the cellular telephone device 1 detected by the opening-and-closing sensor 45. More specifically, in a case in which the opened state of the cellular telephone device 1 is detected by the opening-and-closing sensor 45, the control unit 44 switches the switch 43 such that the first portion 41 and the second portion 42 are connected at high frequency. Moreover, in a case in which the closed state of the cellular telephone device 1 is detected by the opening-and-closing sensor 45, the control unit 44 switches the switch 43 such that the first portion 41 and the second portion 42 are cut off at high frequency. Here, the first portion 41 and the second portion 42 configure a part of the second conductive portion 400, and are configured to be disposed adjacently to each other in the alignment direction (here, the longitudinal direction of the cellular telephone device 1) of the first conductive portion 31 and the second conductive portion 400 in the opened state of the cellular telephone device 1.

In the cellular telephone device 1 of the first embodiment including the aforementioned configuration, the second conductive portion 400 in the display unit side body 3 is electrically connected to the power feed unit 36, and thus functions as a radiating element of the antenna; and the first conductive portion 31 in the operation unit side body 2 is electrically connected to the ground unit 35, and thus functions as a ground unit of the antenna. Therefore, the entirety of the display unit side body 3 and the operation unit side body 2 configures a single antenna.

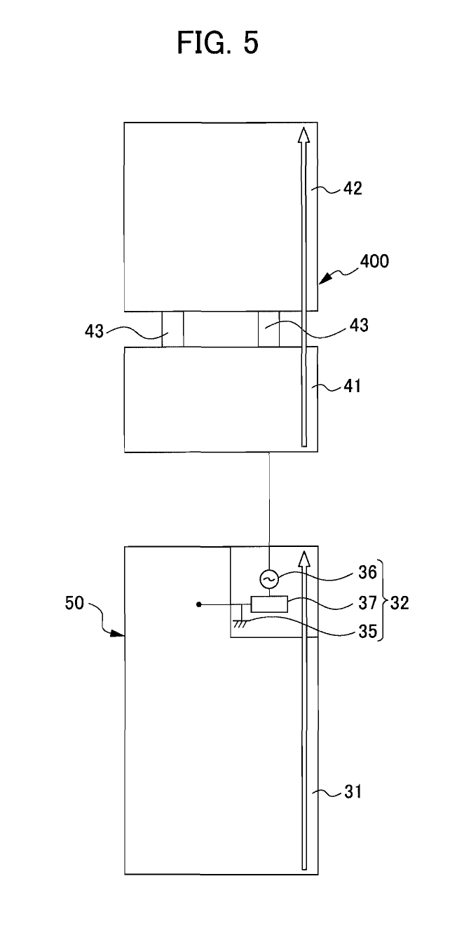

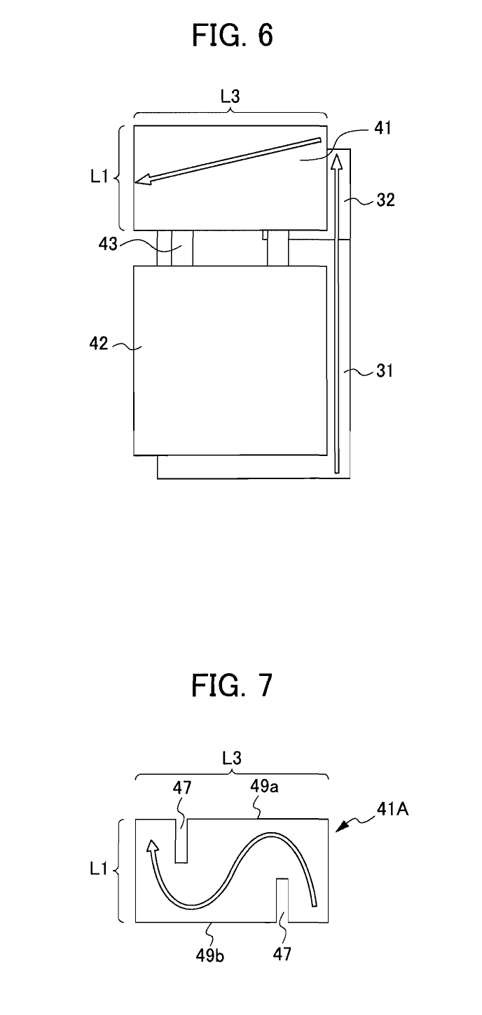

Next, a description is provided for a flow of a high-frequency current in each of the opened state and the closed state of the cellular telephone device 1 of the first embodiment with reference to FIGS. 5 and 6. FIG. 5 is diagram schematically showing a flow of a high-frequency current in the opened state of the cellular telephone device 1. FIG. 6 is diagram schematically showing a flow of a high-frequency current in the closed state of the cellular telephone device 1.

As shown in FIG. 5, in the opened state of the cellular telephone device 1, the control unit 44 switches the switch 43 such that the first portion 41 and the second portion 42 are connected at high frequency. As a result, in the display unit side body 3, a high-frequency current flows between the first portion 41 and the second portion 42 of the second conductive portion 400 (see a directional arrow in FIG. 5).

Here, since the first conductive portion 31 is connected to the ground unit 35 of the circuit unit 32, the first conductive portion 31 functions as a ground unit of the antenna. In addition, since the first portion 41 of the display unit side body 3 is connected to the power feed unit 36, the second conductive portion 400 that is composed of the first portion 41 and the second portion 42 is in a state of being connected to the power feed unit 36. As a result, as indicated by the directional arrows in FIG. 5, the high-frequency current flows along the longitudinal direction of the cellular telephone device 1, in each of the operation unit side body 2 and the display unit side body 3.

On the other hand, as shown in FIG. 6, in the closed state of the cellular telephone device 1, the control unit 44 switches the switch 43 such that the first portion 41 and the second portion 42 are cut off at high frequency. As a result, in the display unit side body 3, the high-frequency current flows only in the first portion 41 of the second conductive portion 400 (see a directional arrow in FIG. 6).

Here, since the length L1 of the first portion 41 is set to be no more than half the length L2 of the second portion 42, the length L1 along the alignment direction of the first conductive portion 31 and the second conductive portion 400 (see FIG. 5) is shorter than a width L3 in a direction orthogonal to the alignment direction (see FIG. 6). As a result, in the display unit side body 3, as indicated by the directional arrow in FIG. 6, the high-frequency current flows through the first portion 41 in a diagonal direction. The flow direction of the high-frequency current flowing through the first portion 41 has a predetermined angle with respect to the flow direction of the high-frequency current flowing through the first conductive portion 31.

According to the cellular telephone device 1 as described above, the first portion 41 and the second portion 42 are connected at high frequency in the opened state of the cellular telephone device 1. As a result, the first portion 41 and the second portion 42 of the second conductive portion 400 function as an antenna element, the first conductive portion 31 functions as a ground unit, and a dipole antenna can be configured with the first conductive portion 31 and the second conductive portion 400.

Moreover, in the closed state of the cellular telephone device 1, the second portion 42 of the second conductive portion 400 is cut off from the first conductive portion 31 at high frequency, and thus the high-frequency current flows through the first portion 41 in the diagonal direction. Since the flow direction of this high-frequency current has a predetermined angle with respect to the flow direction of the high-frequency current flowing through the first conductive portion 31, the high-frequency currents are not cancelled by each other, and thus the antenna gain can be prevented from being deteriorated.

In this way, according to the cellular telephone device 1 of the first embodiment, satisfactory antenna characteristics can be obtained in both of the opened state and the closed state. In addition, if the control unit 44 is configured to connect or cut off the first portion 41 and the second portion 42 at high frequency such that a high-frequency transmission path length in the first portion 41 in the closed state of the cellular telephone device 1 is different from a high-frequency transmission path length in the first portion 41 and the second portion 42 in the opened state thereof, the second conductive portion 400 can transmit or receive a signal at different frequency depending on the opened state and the closed state; therefore, a multiband-compatible antenna is configured with a simple configuration, while suppressing the deterioration of the antenna characteristics regardless of the opened state and the closed state.

Furthermore, in such a case where the control unit 44 performs control such that the high-frequency transmission path length in the first portion 41 in the closed state of the cellular telephone device 1 is different from the high-frequency transmission path length in the first portion 41 and the second portion 42 in the opened state thereof, it is preferable that the high-frequency transmission path length in the first portion 41 is a length corresponding to the high-frequency frequency band that is used for exercising a communication function that does not use the display unit 21, and the high-frequency transmission path length in the first portion 41 and the second portion 42 is a length corresponding to the high-frequency frequency band that is used for exercising a communication function that uses the display unit 21.

Here, the function that does not use the display unit 21 corresponds to, for example, a GPS (Global Positioning System) communication function, an infrared communication function, RFID (Radio Frequency Identification) and the like; and the function that uses the display unit 21 corresponds to, for example, a receiving function of terrestrial digital broadcasting and the like.

By doing this way, it is possible to perform appropriate multiband-compatible communication in each of the closed state in which the display unit 21 is not assumed to be used, and the opened state in which the display unit 21 is assumed to be used.

It should be noted that, as a further preferable mode, in a case in which the opened state is detected by the opening-and-closing sensor 45 when exercising (executing) a predetermined function in the closed state by using high frequency transmitted to the first portion 41, the control unit 44 may maintain the state of cutting off the first portion 41 and the second portion 42 until an operation of the predetermined function is suppressed (suspended or terminated). In addition, by being triggered by suppression of the operation of the predetermined function, the control unit 44 connects the first portion 41 and the second portion 42.

Moreover, in a case in which the closed state is detected by the opening-and-closing sensor 45 when exercising (executing) a predetermined function in the opened state by using high frequency transmitted to the first portion 41 and the second portion 42, the control unit 44 may maintain the state of connecting the first portion 41 and the second portion 42 until an operation of the predetermined function is suppressed (suspended or terminated). In addition, by being triggered by suppression of the operation of the predetermined function, the control unit 44 cuts off the first portion 41 and the second portion 42.

By doing this way, even in a case in which the operation unit side body 2 and the display unit side body 3 transition between the opened state and the closed state, a predetermined function being executed can be continuously used, and appropriate multiband-compatible communication is possible in a state in which the operation of the predetermined function is suppressed.

In this way, the cellular telephone device 1 of the first embodiment can preferably exercise communication functions that use signals in various frequency bands, such as a signal of terrestrial digital broadcasting, a signal of CDMA (Code Division Multiple Access) communication, a signal of GPS (Global Positioning System) communication, a signal of wireless LAN, a signal of RFID (Radio Frequency Identification), etc.

### Second Embodiment

FIG. 7 shows a first portion 41A in a second embodiment of the present invention. Configurations of the other members are the same as those in the first embodiment shown in FIGS. 1 to 6. The first portion 41A, together with the second portion 42 and the switch 43 disposed therebetween (not illustrated), configures the second conductive portion 400 of the display unit side body 3.

Slits 47 are formed in the first portion 41A At least one slit 47 is formed in the first portion 41A. Moreover, the slits 47 are formed to extend in a direction along the alignment direction of the first conductive portion 31 and the second conductive portion 400 in the opened state of the cellular telephone device 1.

In the second embodiment, one slit 47 is formed in each of opposing sides 49a and 49b that extend in the longitudinal direction of the first portion 41A. The slits 47 are formed in positions being deviated to the right and left in the opposing sides 49a and 49b; and in FIG. 7, the slit 47 on the opposing side 49b side is positioned to the right side, and the slit 47 on the opposing side 49a side is positioned to the left side. In addition, each of the slits 47 is formed to have a predetermined length in a direction along the alignment direction of the first conductive portion 31 and the second conductive portion 400 in the first portion 41A.

The directional arrow in FIG. 7 indicates the flow of a high frequency current in the first portion 41A in the closed state of the cellular telephone device 1. Here, since the slits 47 are formed in the first portion 41A, the high-frequency current flows so as to avoid the slits 47, as indicated by the directional arrow. This high-frequency current meanderingly flows along the longitudinal direction of the first portion 41A (in other words, the lateral direction of the first portion 41A). Since the flow direction of this high-frequency current are not overlapped with the high-frequency current flowing through the operation unit side body 2, the high-frequency currents are not cancelled by each other, and thus the antenna gain can be prevented from being deteriorated. Moreover, since the length of the flow of the high frequency current in the first portion 41A can be lengthened, compatibility with a low-frequency band can also be achieved. Furthermore, since the length of the flow (the transmission path length) of the high frequency current can be adjusted by the layout of the slits 47 or the like, it is possible to configure an antenna that is compatible with various frequencies. It should be noted that, in a case in which signals at the same frequency are transmitted and received in the opened state and the closed state, the length of the flow of the high frequency current adjusted by the slits 47 may be configured to be substantially the same as the length of the first conductive portion 31 in the alignment direction of the first conductive portion 31 and the second conductive portion 400 in the opened state (in the longitudinal direction of the cellular telephone device 1 in this case). As a result, the deterioration of the antenna characteristics at the same frequency can be suppressed regardless of the opened state and the closed state of the cellular telephone device 1.

Although the preferable embodiments have been described above, the present invention is not limited to the aforementioned embodiments, and can be implemented as various embodiments. For example, the circuit unit 32 is disposed in the operation unit side body 2 in the first and second embodiments, but may be disposed in the display unit side body 3. In this case, operations similar to those in the first and second embodiments can be achieved, by connecting the second conductive portion in the display unit side body 3 to the ground unit of the circuit unit, and connecting the first conductive portion 31 in the operation unit side body 2 to the power feed unit of the circuit unit.

Moreover, although the second conductive portion 400 is configured with two conductive portions composed of the first portion 41 and the second portion 42 in the first and second embodiments, the present invention is not limited thereto. In other words, the second conductive portion 400 may be configured with three or more conductive portions.

In addition, although the switch 43 is used to mechanically connect and cut off the first portion 41 and the second portion 42 in the first and second embodiments, the present invention is not limited thereto. In other words, instead of the switch 43, a resonance circuit may be used, or a semiconductor switch formed on a circuit board may be used.

Furthermore, although the first portion 41 and the second portion 42 are connected by the two switches 43 in the first and second embodiments, the present invention is not limited thereto. In other words, the first portion and the second portion may be connected at one point, or may be connected at three or more points.

Moreover, although the first conductive portion 31 and the second conductive portion 400 are configured with a circuit board in the first and second embodiments, the present invention is not limited thereto. In other words, the first conductive portion 31 and the second conductive portion 400 may be configured with a shielding case or the like.

### Third Embodiment

Next, a third embodiment of the cellular telephone device 1 according to the present invention is described. The third embodiment is described mainly in terms of differences from the first and second embodiments, and configurations similar to those in the first and second embodiments are assigned with the same reference symbols, and descriptions thereof are omitted. The descriptions regarding the first and second embodiments are applied as appropriate where a description is not particularly provided for the third embodiment.

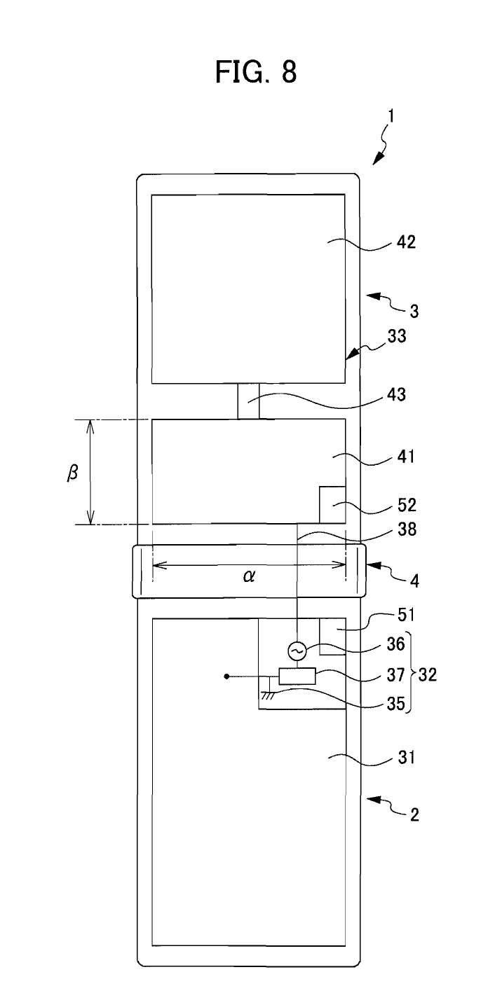

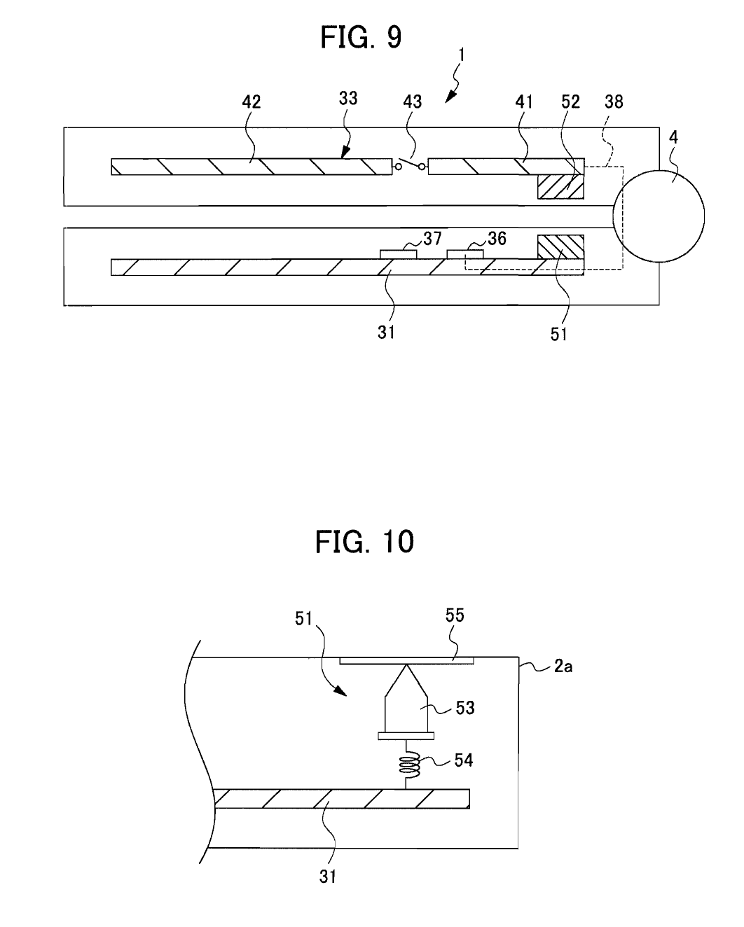

Next, internal structures of the operation unit side body 2 and the display unit side body 3 are described with reference to FIGS. 8 and 9. FIG. 8 is a front view schematically showing the inside of the cellular telephone device 1 in the opened state. FIG. 9 is a lateral view schematically showing the inside of the cellular telephone device 1 in the closed state. It should be noted that, in FIGS. 8 and 9, only the circuit unit 32, the first conductive portion 31, a first capacitive coupling portion 51 and the like are virtually shown with regard to components in the operation unit side body 2, and only a second conductive portion 33, a second capacitive coupling portion 52 and the like are virtually shown with regard to components in the display unit side body 3.

As shown in FIGS. 8 and 9, the operation unit side body 2 includes the first conductive portion 31, the circuit unit 32 and the first capacitive coupling portion 51, within the inside thereof, more specifically between the front case 2a and the rear case 2b. In the present embodiment, the first conductive portion 31 is configured with a circuit board on which electronic components are mounted, a shielding member in a state of being connected to such a circuit board, and the like; and the circuit unit 32 is configured with a circuit board on which electronic components are mounted, and the like.

The first conductive portion 31 is configured with a ground pattern formed on the circuit board. The circuit unit 32 includes the ground unit 35, the power feed unit 36, the signal processing unit 37 that is connected to the ground unit 35 and the power feed unit 36, and a signal line 38. The ground unit 35 is connected to the first conductive portion 31. The power feed unit 36 is connected at high frequency to the second conductive portion 33 disposed in the display unit side body 3, and feeds power to the second conductive portion 33. More specifically, the power feed unit 36 is connected through the signal line 38 to the first portion 41 that is positioned on the connecting portion 4 side in the second conductive portion 33, which will be described later. The signal processing unit 37 is configured with: the radio circuit including the RF circuit; the matching circuit; the control circuit; and the like. In the signal processing unit 37, predetermined processing is performed on a signal fed from the power feed unit 36. The first capacitive coupling portion 51 is disposed at a corner on one side in the end portion on the connecting portion 4 side of the circuit unit 32. Details of the first capacitive coupling portion 51 will be described later.

The display unit side body 3 is connected to the operation unit side body 2 via the connecting portion 4, such that a state of being superimposed with the operation unit side body 2 can be formed. The display unit side body 3 includes the second conductive portion 33 and the second capacitive coupling portion 52, within the inside thereof, more specifically between the front case 3a and the rear case 3b. In the present embodiment, the second conductive portion 33 is formed with: the first portion 41; the second portion 42; and the switch 43 (a first selection unit) that is provided therebetween, and connects and separates the first portion 41 and the second portion 42. Both of the first portion 41 and the second portion 42 are configured with a circuit board, a shielding case on which electronic components are mounted, and the like.

The first portion 41 and the second portion 42 are disposed adjacently to each other along the alignment direction of the first conductive portion 31 and the second conductive portion 33 in the state in which the operation unit side body 2 and the display unit side body 3 are opened. More specifically, the first portion 41 is disposed on the connecting portion 4 side (bottom side in FIG. 8), and the second portion 42 is disposed on the side opposite to the connecting portion 4.

The switch 43 is configured so as to be capable of switching between a first state in which the first portion 41 and the second portion 42 are connected, and a second state in which the first portion 41 and the second portion 42 are separated. More specifically, the switch 43 mechanically connects and cuts off the first portion 41 and the second portion 42, by way of a movable contact moving between fixed contacts that are provided to the first portion 41 side and the second portion 42 side, respectively.

The second capacitive coupling portion 52 is disposed in a position corresponding to the first capacitive coupling portion 51. More specifically, the second capacitive coupling portion 52 is disposed at a corner on one side in the end portion on the connecting portion 4 side of the first portion 41 in the second conductive portion 33. In a state in which the operation unit side body 2 and the display unit side body 3 are superimposed with each other (in other words, in the closed state of the cellular telephone device 1), the second capacitive coupling portion 52 is positioned so as to be superimposed with the first capacitive coupling portion 51 when viewed in a direction (a vertical direction in FIG. 9) in which the operation unit side body 2 and the display unit side body 3 are superimposed with each other.

Next, configurations of the first capacitive coupling portion 51 and the second capacitive coupling portion 52 are described with reference to FIG. 10. FIG. 10 is a cross-sectional view showing the vicinity of the first capacitive coupling portion 51. The second capacitive coupling portion 52 is configured similarly to the first capacitive coupling portion 51. Accordingly, a description is provided for the first capacitive coupling portion 51, and a description is omitted for the second capacitive coupling portion 52.

As shown in FIG. 10, the first capacitive coupling portion 51 is configured to include: a plate member 55 that is disposed on an inner wall of the operation unit side body 2; a conductive pin 53 that is disposed such that the tip side thereof is in contact with the plate member 55; and a coil 54 as an inductive member, in which one end thereof is connected to the first conductive portion 31, and an other end thereof is connected to the bottom side of conductive pin 53. It should be noted that the coil 54 can be replaced with another inductive member such as, for example, a chip coil.

The plate member 55 is provided on an inner surface of the top face of the front case 2a. The plate member 55 is configured by, for example, forming sheet metal inserted into the front case 2a, depositing conductive metal on the inner wall of the front case 2a that is resin-molded, performing conductive coating, or sticking conductive sheet metal on the inner wall of the front case 2a. The coil 54 is indirectly connected to the plate member 55 via the conductive pin 53. As a result, by connecting the coil 54 to the conductive pin 53 and the plate member 55, in combination with the second capacitive coupling portion 52, an LC resonance circuit composed of a capacitor and a coil can be formed. In other words, the plate member 55 of the first capacitive coupling portion 51 and the second capacitive coupling portion 52 (more specifically, the plate-like member of the second capacitive coupling portion 52) form a C (capacitive) component of the LC resonance circuit, and the coil 54 connected thereto forms an L (inductive) component of the LC resonance circuit.

The first capacitive coupling portion 51 as described above is in contact with the inner wall of the front case 2a, and the second capacitive coupling portion 52 is provided similarly to the first capacitive coupling portion 51, thereby achieving a structure in which a coupling distance between the first capacitive coupling portion 51 and the second capacitive coupling portion 52 is short. This is advantageous for capacitive coupling.

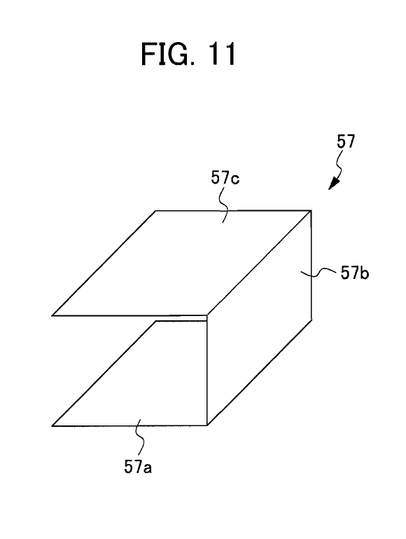

FIG. 11 is a view showing a sheet metal member 57 as another example of the first capacitive coupling portion 51. The sheet metal member 57 is U-shaped such that plate pieces 57a and 57c extend in the same direction from upper and lower ends of a connecting piece 57b. One of the plate piece 57a or the plate piece 57c abuts on, or is adjacent to, the inner wall of the front case 2a, and an other one thereof is connected to the first conductive portion 31, and thus the sheet metal member 57 functions as a capacitive coupling portion.

According to the cellular telephone device 1 of the third embodiment as described above, the second conductive portion 33 in the display unit side body 3 is electrically connected to the power feed unit 36, and thus functions as a radiating element of the antenna; and the first conductive portion 31 in the operation unit side body 2 is electrically connected to the ground unit 35, and thus functions as a ground unit of the antenna. Therefore, in the opened state of the cellular telephone device 1, the entirety of the first conductive portion 31 and the second conductive portion 33 configures an antenna (for example, a dipole antenna).

Moreover, in the closed state of the cellular telephone device 1, the first capacitive coupling portion 51 and the second capacitive coupling portion 52 are superimposed with each other, and as a result of such superimposition, the first conductive portion 31 and the second conductive portion 33 are equivalent to the capacitor. As a result, the first conductive portion 31 and the second conductive portion 33 are capacitively coupled, and the first conductive portion 31 and the second conductive portion 33 configure a so-called antenna (for example, an inverted F antenna).

According to the cellular telephone device 1 of the third embodiment, in the opened state of the cellular telephone device 1, the entirety of the first conductive portion 31 and the second conductive portion 33 configures an antenna, and satisfactory antenna characteristics can be obtained. On the other hand, in the closed state of the cellular telephone device 1, the first conductive portion 31 and the second conductive portion 33 are capacitively coupled via the first capacitive coupling portion 51 and the second capacitive coupling portion 52, and as a result, the first conductive portion 31 and the second conductive portion 33 can function as a so-called antenna. Accordingly, satisfactory antenna characteristics can be obtained in both of the opened state and the closed state of the cellular telephone device 1. In addition, since the first conductive portion 31 and the second conductive portion 33 are capacitively coupled, the first conductive portion 31 and the second conductive portion 33 can be disposed inside the operation unit side body 2 and the display unit side body 3, respectively; therefore, as compared to a case of disposing them outside, the electrostatic effect and the water/dust-proof effects can be expected to be improved, and at the same time, an effect of suppressing corrosion of the first conductive portion 31 and the second conductive portion 33 can also be expected.

Furthermore, according to the cellular telephone device 1 of the third embodiment, the first capacitive coupling portion 51 and the second capacitive coupling portion 52 are configured to include the coil 54 having inductivity. As a result, the LC resonance circuit is formed in the closed state of the cellular telephone device 1. Here, C according to capacitive coupling depends on the terminal structure and the size of coupling means, and cannot be always freely set; however, since the LC resonance circuit is formed in this way, impedance adjustment is easily possible by way of an L value, and a desirable inverted F antenna can be preferably obtained in the closed state.

Here, a description is provided for a technique to resonate the first portion 41 at predetermined frequency A, in a case in which the power feed unit 36 feeds power to the first portion 41 that is separated from the second portion 42 (in other words, in a case in which only the first portion 41 functions as an antenna).

First, the first portion 41 and the second portion 42 are separated by the switch 43. Alternatively, by employing a configuration to cut off a frequency A band by way of frequency selection means such as a resonance circuit, the first portion 41 and the second portion 42 are cut off at high frequency in the frequency A band.

In addition, as shown in FIG. 8, when a length of the first portion 41 along the direction orthogonal to the longitudinal direction of the display unit side body 3 (the length in the lateral direction) is α, and a length along the longitudinal direction of the display unit side body 3 (the length in the longitudinal direction) is β, then a total length thereof (α+β) is set to be λ/4 or λ/2 with regard to a wavelength λ of the frequency A. As a result, the first portion 41 can be resonated at the frequency A.

Moreover, it is also effective to cause the frequency resonating in the first portion 41 to substantially coincide with the frequency resonating in the LC resonance circuit. More specifically, setting is performed so as to satisfy conditions expressed by the following equations (1) and (2). In the equations (1) and (2), L is inductance of the resonance circuit, C is capacity of the resonance circuit, and K is speed of light.

A=1/(2π√(L×C)) (1)

(K/A)/4 (or 2)=α+β (2)

By setting so as to satisfy the equations (1) and (2), the portion coupled by the first capacitive coupling portion 51 and the second capacitive coupling portion 52 can equivalently be in a short circuit state, and thus can operate as an antenna in both of the opened state and the closed state of the cellular telephone device 1.

In addition, according to the cellular telephone device 1 of the third embodiment, in the first state, the second conductive portion 33 is in a state of being formed with the first portion 41 and the second portion 42; and in the second state, the second conductive portion 33 is in a state of being formed with only the first portion 41. In this way, selection by the switch 43 allows change into the first state and the second state, and as a result, resonation is possible at a plurality of frequencies. As a result, a multiple-resonant antenna can be configured.

Moreover, in the third embodiment, in the closed state of the cellular telephone device 1, it is preferable that the second portion 42 is in the second state of being separated from the first portion 41. In other words, in the closed state of the cellular telephone device 1, only the first portion 41 is in the state of being connected to the first conductive portion 31 of the operation unit side body 2, and in this state, the high-frequency current flows through the first portion 41 in the diagonal direction. This is because the length β along the alignment direction of the first conductive portion 31 and the second conductive portion 33 in the first portion 41 (see FIG. 8) is shorter than the width α in the direction orthogonal to the alignment direction (see FIG. 8). As a result, in the closed state of the cellular telephone device 1, the flow direction of the high-frequency current in the second conductive portion 33 (the first portion 41) has a predetermined angle with respect to the flow direction of the high-frequency current in the first conductive portion 31, and thus the high-frequency currents are not cancelled by each other. Therefore, the antenna characteristics in the closed state of the cellular telephone device 1 can be prevented from being deteriorated.

The cellular telephone device 1 of the third embodiment can be applied to a signal of terrestrial digital broadcasting, a signal of CDMA (Code Division Multiple Access) communication, a signal of GPS (Global Positioning System) communication, a signal of wireless LAN, a signal of RFID, etc.

Although the preferable embodiments have been described above, the present invention is not limited to the aforementioned embodiments, and can be implemented as various embodiments. For example, the first capacitive coupling portion 51 and the second capacitive coupling portion 52 are disposed in the operation unit side body 2 and the display unit side body 3, respectively, but may be disposed in any one of the operation unit side body 2 and the display unit side body 3. Moreover, since it is sufficient to capacitively couple the first conductive portion 31 and the second conductive portion 33, even without the first capacitive coupling portion 51 and the second capacitive coupling portion 52, as long as such a configuration enables capacitive coupling in the closed state, the first capacitive coupling portion 51 and the second capacitive coupling portion 52 may not be provided.

In addition, although the plate member 55, the conductive pin 53 and the coil 54 configure the first capacitive coupling portion 51 and the second capacitive coupling portion 52 in the third embodiment, it is not limited thereto. In other words, a circuit board on which electronic components are mounted may be used as the first conductive portion 31 and the second conductive portion 33, and the electronic components mounted on the circuit board may configure the first capacitive coupling portion 51 and the second capacitive coupling portion 52. As a result, the electronic components can be effectively utilized.

Furthermore, the second conductive portion 33 is formed with the two conductor portions composed of the first portion 41 and the second portion 42, but it is not limited thereto, and may be formed with three or more conductor portions.

Moreover, in the third embodiment, as an example of the first selection unit, the mechanical switch is described as the switch 43 that cuts off and connects the first portion 41 and the second portion 42 at high frequency; however, the first selection unit is not limited thereto, and may be a resonance circuit or a semiconductor switch formed on a circuit board.

### Fourth Embodiment

Next, a fourth embodiment of the cellular telephone device 1 according to the present invention is described. The fourth embodiment is described mainly in terms of differences from the third embodiment, and configurations similar to those in the third embodiment are assigned with the same reference symbols, and descriptions thereof are omitted. The description regarding the third embodiment is applied as appropriate where a description is not particularly provided for the fourth embodiment.

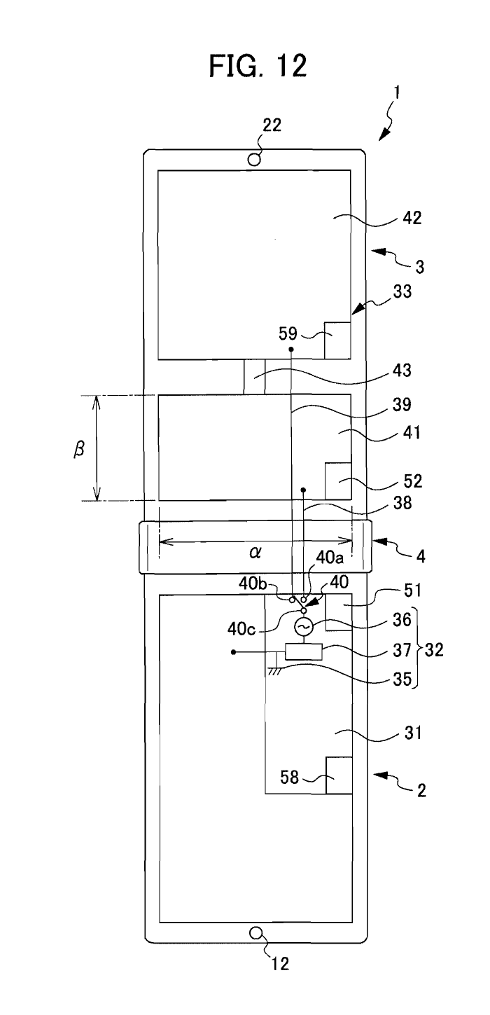

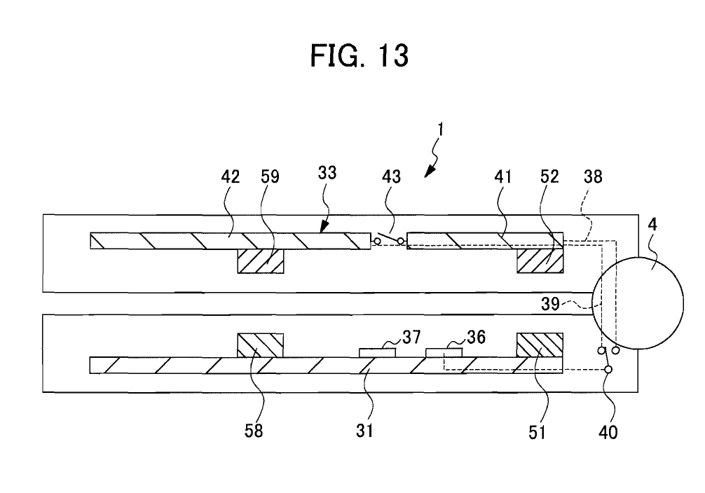

FIG. 12 is a front view schematically showing an inside of the cellular telephone device 1 of the fourth embodiment in the opened state. FIG. 13 is a lateral view schematically showing the inside of the cellular telephone device 1 of the fourth embodiment in the closed state.

The cellular telephone device 1 of the fourth embodiment is different from the aforementioned third embodiment mainly in the point that a third capacitive coupling portion 58, a fourth capacitive coupling portion 59, a signal line 39 and a switch 40 are provided.

As shown in FIGS. 12 and 13, the third capacitive coupling portion 58 is disposed at a corner in the end portion on the microphone 12 side of the circuit unit 32. It should be noted that it is sufficient to capacitively couple the third capacitive coupling portion 58 and the fourth capacitive coupling portion 59, and the third capacitive coupling portion 58 may not necessarily be disposed at a corner in the end portion on the microphone 12 side of the circuit unit 32.

In a state in which the operation unit side body 2 and the display unit side body 3 are superimposed with each other (in other words, in the closed state of the cellular telephone device 1), the fourth capacitive coupling portion 59 is positioned in a position that is superimposed with the third capacitive coupling portion 58 when viewed in a direction in which the operation unit side body 2 and the display unit side body 3 are superimposed with each other (a vertical direction in FIG. 13). More specifically, the fourth capacitive coupling portion 59 is disposed at a corner in the end portion on the connecting portion 4 side of the second portion 42 in the second conductive portion 33.

The signal line 38 is electrically connected to the first portion 41, and is connected to the switch 40 via the connecting portion 4. The signal line 39 is electrically connected to the second portion 42, and is connected to the switch 40 via the connecting portion 4.

The switch 40 (a second selection unit) selects one of a first connection state in which the first portion 41 and the power feed unit 36 are electrically connected, and a second connection state in which the second portion 42 and the power feed unit 36 are electrically connected.

More specifically, the switch 40 is disposed in the operation unit side body 2 side, and selects the first connection state or the second connection state, by way of a movable contact 40c to be connected to one of a fixed contact 40a on the signal line 38 side or a fixed contact 40b on the signal line 39 side.

Next, a description is provided for a specific operational example in a case in which the cellular telephone device 1 functions as antenna, with reference to FIG. 13.

In the closed state of the cellular telephone device 1, the switch 40 selects the first connection state in which the first portion 41 and the power feed unit 36 are connected. Moreover, the switch 43 selects the second state in which the first portion 41 and the second portion 42 are separated. In addition, the first conductive portion 31 and the first portion 41 are capacitively coupled by the first capacitive coupling portion 51 and the second capacitive coupling portion (a first capacitive coupling portion). It should be noted that the control unit (not illustrated) appropriately performs switching control of the switch 40 and the switch 43.

In other words, the first portion 41, the power feed unit 36, the first capacitive coupling portion 51, the second capacitive coupling portion 52 and the first conductive portion 31 are configured as, for example, an antenna element (for example, an inverted F antenna) that resonates in a usable frequency band fa.

In such a configuration, the first portion 41 operates as a radiating element in the antenna element. In addition, the power feed unit 36 feeds power to the first portion 41, and the first capacitive coupling portion 51 and the second capacitive coupling portion 52 operate as a short circuit unit. Furthermore, the first conductive portion 31 operates as a ground side in the antenna element.

On the other hand, in the closed state of the cellular telephone device 1, the switch 40 selects the second connection state in which the second portion 42 and the power feed unit 36 are connected. Moreover, the switch 43 selects the second state in which the first portion 41 and the second portion 42 are separated. In addition, the first conductive portion 31 and the second portion 42 are capacitively coupled by the third capacitive coupling portion 58 and the fourth capacitive coupling portion 59 (a second capacitive coupling portion).

In other words, the second portion 42, the power feed unit 36, the third capacitive coupling portion 58, the fourth capacitive coupling portion 59 and the first conductive portion 31 are configured as, for example, an antenna element (for example, an inverted F antenna) that resonates in a usable frequency band fb.

In such a configuration, the second portion 42 operates as a radiating element in the antenna element. Moreover, the power feed unit 36 feeds power to the second portion 42, and the third capacitive coupling portion 58 and the fourth capacitive coupling portion 59 operate as a short circuit unit. Furthermore, the first conductive portion 31 operates as a ground side in the antenna element. It should be noted that the usable frequency bands fa and fb are set based on the length in the longitudinal direction and the length in the lateral direction of the first portion 41 or the second portion 42 which operates as a radiating element.

Moreover, although the first and second embodiment describe a configuration example in which the capacitive coupling portions are capacitively coupled, the first conductive portion 31 and the second conductive portion 33 may be directly connected.

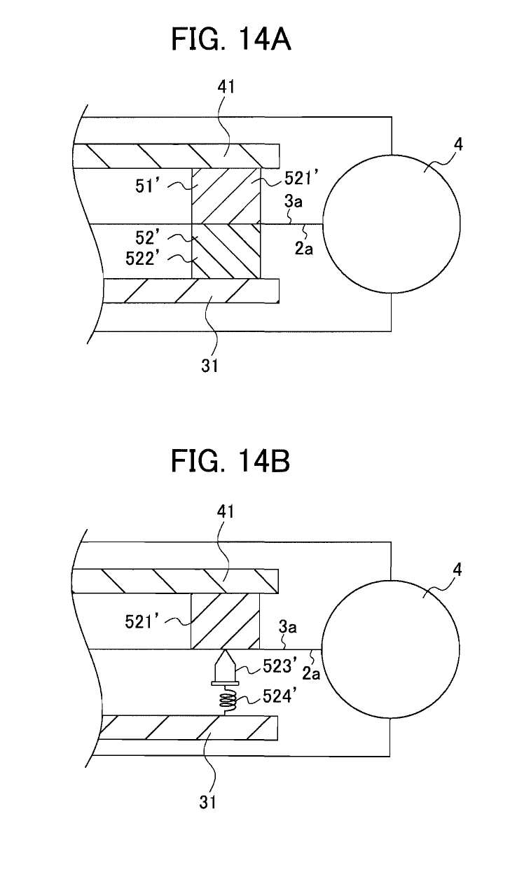

FIG. 14 is a cross-sectional view schematically showing a configuration of a vicinity of a first coupling portion 51′ and a second coupling portion 52′. FIG. 14A is a cross-sectional view showing a configuration in a case in which a sheet metal member 521′ and a sheet metal member 522′ are used as the first coupling portion 51′ and the second coupling portion 52′; and FIG. 14B is a cross-sectional view showing a configuration in a case in which the sheet metal member 521′, a conductive pin 523′ and a coil 524 are used as the first coupling portion 51′ and the second coupling portion 52′. Here, since a third coupling portion 58′ and a fourth coupling portion 59′ have a similar configuration, a description is provided for the first coupling portion 51′ and the second coupling portion 52′, and a description is omitted for the third coupling portion 58′ and the fourth coupling portion 59′.

The sheet metal member 521′ and the sheet metal member 522′ shown in FIG. 14A correspond to a sheet metal member 57′. More specifically, as for the sheet metal member 521′, one of the plate piece 57a′ or the plate piece 57c′ is disposed on the same plane as the outer wall of the front case 2a, and an other one thereof is connected to the first conductive portion 31. Similarly, as for the sheet metal member 522′, one of the plate piece 57a′ or the plate piece 57c′ is disposed on the same plane as the outer wall of the front case 3a, and an other one thereof is connected to the second conductive portion 33.

In addition, in the closed state of the cellular telephone device 1, the plate piece of the sheet metal member 521′ disposed on the same plane as the outer wall of the front case 2a and the plate piece of the sheet metal member 522′ disposed on the same plane as the outer wall of the front case 3a abut on and are connected with each other at high frequency.

The conductive pin 523′ and the coil 524′ shown in FIG. 14B correspond to a conductive pin 53′ and a coil 54′, respectively. Moreover, the tip of the conductive pin 523′ is exposed to the outside through the inner wall of the front case 2a. In addition, in the closed state of the cellular telephone device 1, the plate piece of the sheet metal member 521′ disposed on the same plane as the outer wall of the front case 2a and the tip of the conductive pin 523′ abut on, and are connected with, each other at high frequency.

According to the cellular telephone device 1 of the fourth embodiment, the following effects can be achieved. The cellular telephone device 1 of the fourth embodiment includes the switch 40 that selects, in the closed state of the cellular telephone device 1, one of the first connection state in which the first portion 41 and the power feed unit 36 are connected, and the second connection state in which the second portion 42 and the power feed unit 36 are connected. Accordingly, it is possible to achieve compatibility with usable frequency bands that are different between the first connection state and the second connection state. Therefore, the cellular telephone device 1 can realize a so-called multiband antenna that is compatible with a plurality of usable frequency bands that are different between the first connection state and the second connection state in the opened state and the closed state.

Moreover, the cellular telephone device 1 of the fourth embodiment can change the characteristics of the antenna element depending on the first connection state and the second connection state. Accordingly, impedance matching of the antenna element can be preferably performed.

In addition, since the cellular telephone device 1 of the fourth embodiment is compatible with a plurality of usable frequency bands in the closed state of the cellular telephone device 1, functions that use the antenna element in the closed state of the cellular telephone device 1 (for example, GPS, wireless LAN, Bluetooth (registered trademark), etc.) can be more preferably operated.

Although the preferable embodiments have been described above, the present invention is not limited to the aforementioned embodiments, and can be implemented as various embodiments. For example, the mechanistic switches are described as the switch 40 and the switch 43 in the present embodiment, but are not limited thereto, and may be a resonance circuit or a semiconductor switch formed on a circuit board.

Furthermore, the second conductive portion 33 is formed with the two conductor portions composed of the first portion 41 and the second portion 42, but is not limited thereto, and may be formed with three or more conductor portions.

### Fifth Embodiment

Next, a fifth embodiment of the cellular telephone device 1 according to the present invention is described. The fifth embodiment is described mainly in terms of differences from the third embodiment, and configurations similar to those in the third embodiment are assigned with the same reference symbols, and descriptions thereof are omitted. The description regarding the third embodiment is applied as appropriate where a description is not particularly provided for the fifth embodiment.

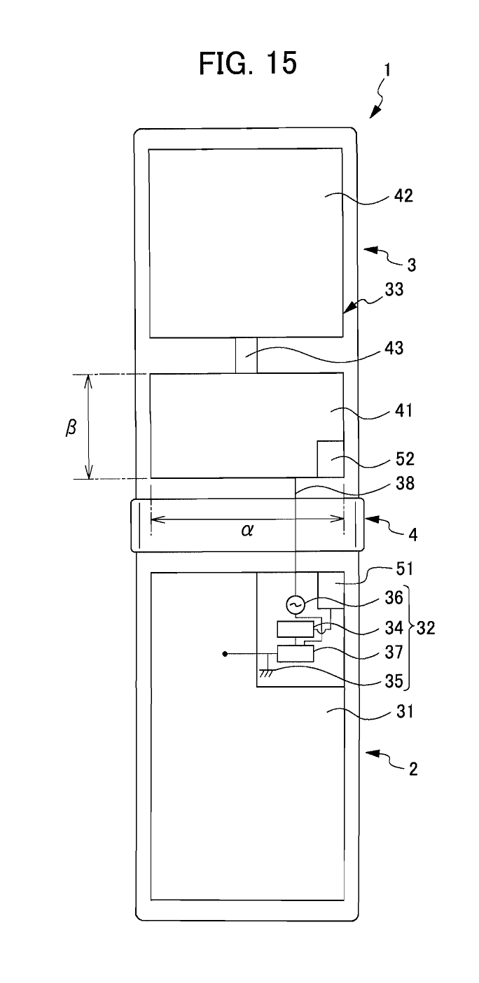

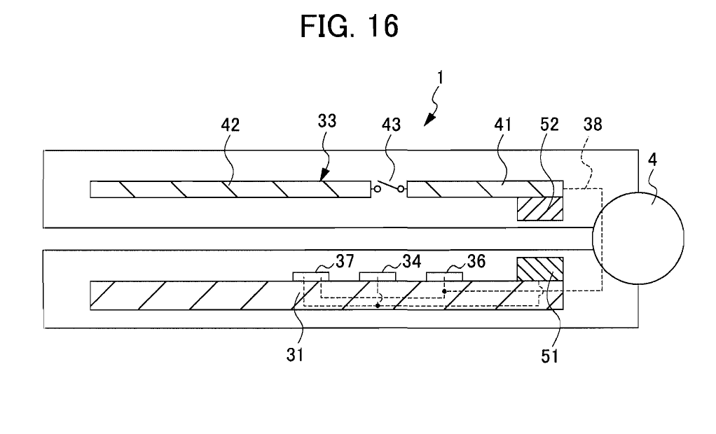

FIG. 15 is a front view schematically showing the inside of the cellular telephone device 1 of the fifth embodiment in the opened state. FIG. 16 is a lateral view schematically showing the inside of the cellular telephone device 1 of the fifth embodiment in the closed state.

The cellular telephone device 1 of the fifth embodiment is different from the third embodiment mainly in the point of including an adjustment unit 34.

As shown in FIGS. 15 and 16, the circuit unit 32 has the adjustment unit 34. The adjustment unit 34 is electrically connected to the signal processing unit 37. In addition, in a case in which the first conductive portion 31 and the second conductive portion 33 are capacitively coupled as a result of the operation unit side body 2 and the display unit side body 3 moving into the closed state, in other words, in a case in which the first capacitive coupling portion 51 and the second capacitive coupling portion 52 are capacitively coupled, the adjusting unit 34 performs adjustment of reactance including electrostatic capacity arising between the first conductive portion 31 (the first capacitive coupling portion 51) and the second conductive portion 33 (the second capacitive coupling portion 52).

Furthermore, the adjustment unit 34 may have a third selection unit for selectively performing the adjustment of reactance.

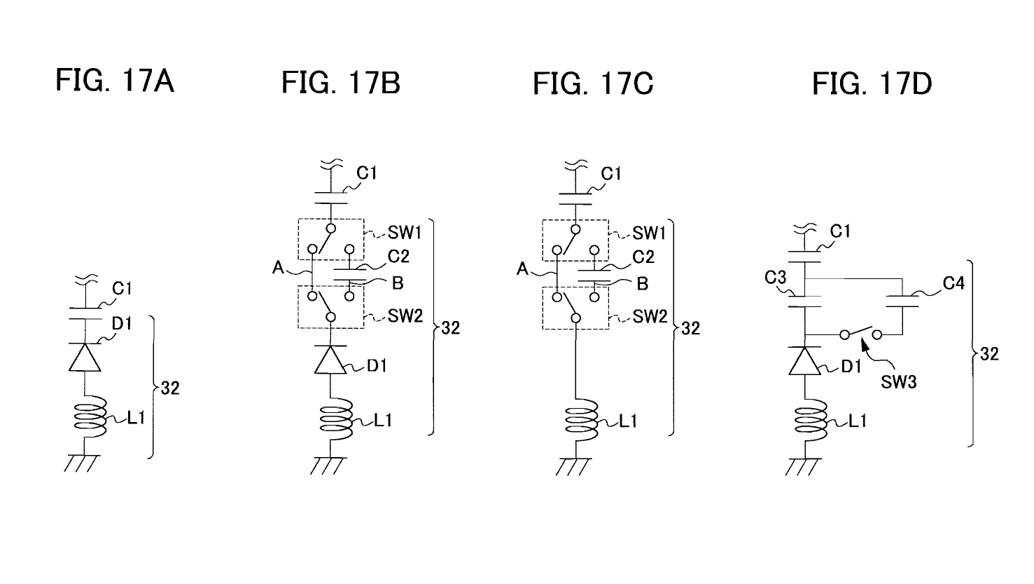

Next, a specific configuration example of the adjustment unit 34 is described with reference to FIGS. 17A to 17D. FIGS. 17A to 17D are diagrams showing an equivalent circuit regarding the first capacitive coupling portion 51, the second capacitive coupling portion 52 and the adjustment unit 34, in a case in which the first capacitive coupling portion 51 and the second capacitive coupling portion 52 are capacitively coupled. It should be noted that the same configurations in FIGS. 17A to 17D are assigned with the same reference symbols, and a description thereof is omitted.

In the equivalent circuit shown in FIG. 17A, a capacitor C1 and the adjustment unit 34 are serially connected. The capacitor C1 indicates electrostatic capacity arising between the first capacitive coupling portion 51 and the second capacitive coupling portion 52 in a case in which the first capacitive coupling portion 51 and the second capacitive coupling portion 52 are capacitively coupled.

The adjustment unit 34 includes a variable capacitance diode D1 and a coil L1.

The variable capacitance diode D1 is electrically connected between the capacitor C1 and the coil L1. The variable capacitance diode D1 can change the electrostatic capacity of the variable capacitance diode D1 itself by changing the voltage applied to variable capacitance diode D1 in accordance with the control by the control unit (not illustrated).

One end of the coil L1 is electrically connected to the variable capacitance diode D1, and an other end thereof is electrically connected to the ground unit 35.

According to such a configuration, the adjustment unit 34 can change the total capacity of the electrostatic capacity of the capacitor C1 and the electrostatic capacity of the variable capacitance diode D1 by way of the variable capacitance diode D1. As a result, in a case in which the operation unit side body 2 and the display unit side body 3 move into the closed state, and the first capacitive coupling portion 51 (the first conductive portion 31) and the second capacitive coupling portion 52 (the second conductive portion 33) are capacitively coupled, and the first conductive portion 31 and the second conductive portion 33 configure a so-called antenna (for example, an inverted F antenna), the adjustment unit 34 can adjust the reactance in the equivalent circuit by way of the variable capacitance diode D1 and the coil L1. Therefore, the adjustment unit 34 can adjust the resonance frequency of the antenna by adjusting the reactance in the equivalent circuit.

An equivalent circuit of FIG. 17B is different from the equivalent circuit of FIG. 17A in the point that a switch SW1 and a switch SW2 as the third selection unit, as well as a capacitor C2 are provided between the capacitor C1 and the variable capacitance diode D1.

One end of the switch SW1 is electrically connected to the capacitor C1. Moreover, an other end of the switch SW1 is electrically connected to any one of a lead wire A (a lead wire on the left side of FIG. 17B that does not have the capacitor C2, or a lead wire B (a lead wire on the right side of FIG. 17B) that has the capacitor C2.

One end of the switch SW2 is connected to any one of the lead wire A or the lead wire B. In addition, an other end of the switch SW2 is electrically connected to the variable capacitance diode D1.

In a case in which the first capacitive coupling portion 51 and the second capacitive coupling portion 52 are capacitively coupled, the switch SW1 and the switch SW2 switch to any one of the lead wire A or the lead wire B, in accordance with the control by the control unit (not illustrated). When the switch SW1 and the switch SW2 are switched to the lead wire A side, the capacitor C1 and the variable capacitance diode D1 are electrically connected. In other words, this circuit configuration is similar to that of FIG. 17A. In this case, similarly to the case of FIG. 17A, the adjustment unit 34 can change the reactance in the equivalent circuit by way of the variable capacitance diode D1 and the coil L1.

On the other hand, when the switch SW1 and the switch SW2 are switched to the lead wire B side, the capacitor C2 is electrically connected between the capacitor C1 and the variable capacitance diode D1. In other words, in this circuit configuration, the capacitor C1 and the capacitor C2 are serially connected. In this case, the adjustment unit 34 can adjust the reactance in the equivalent circuit by way of the variable capacitance diode D1 and the coil L1, and can change the reactance in the equivalent circuit depending on a case in which the capacitor C2 is connected, and a case in which the capacitor C2 is not connected.

Here, in a case in which the variable capacitance diode D1 is used, the variation of the total capacity is small, and thus the variation of the reactance is small. Therefore, the variable capacitance diode D1 is effective when performing small adjustment of a resonance frequency (for example, channel change or fine tuning in the same frequency band). On the other hand, in a case in which the capacitor C2 is used, the variation of the total capacity is large, and thus the variation of the reactance is large. Therefore, the capacitor C2 is effective when performing large adjustment of a resonance frequency (for example, adjustment from 800 MHz to 1.5 GHz).

In this way, according to the configuration shown in FIG. 17B, the adjustment unit 34 can perform large adjustment and small adjustment of a resonance frequency. Therefore, the adjustment unit 34 can more preferably adjust a resonance frequency of the antenna.

Moreover, as shown in FIG. 17C, the adjustment unit 34 may be used in which the variable capacitance diode D1 is removed from the equivalent circuit of FIG. 17B. In the equivalent circuit of FIG. 17C, the adjustment unit 34 can adjust the reactance in the equivalent circuit between a case in which the capacitor C2 is connected, and a case in which the capacitor C2 is not connected.

In addition, in FIGS. 17B and 17C described above, a coil instead of the capacitor C2 may be connected to the adjustment unit 34. As a result, by switching the switch SW1 and the switch SW2, the adjustment unit 34 can adjust the reactance in the equivalent circuit between a case in which the coil is connected, and a case in which the coil is not connected.

An equivalent circuit shown in FIG. 17D is different from the equivalent circuit shown in FIG. 17A in the point that a capacitor C3, a capacitor C4, and a switch SW3 as the third selection unit are electrically connected between the capacitor C1 and the variable capacitance diode D1.

One end of the capacitor C3 is electrically serially connected to the capacitor C1, and an other end thereof is electrically serially connected to the variable capacitance diode D1. The capacitor C4 is connected in parallel with the capacitor C3. One end of the switch SW3 is electrically connected between the capacitor C3 and the variable capacitance diode D1, and an other end thereof is electrically connected to the variable capacitance diode D1 side of the capacitor C4.

In a case in which the first capacitive coupling portion 51 and the second capacitive coupling portion 52 are capacitively coupled, the switch SW3 switches to any one of an ON state or an OFF state, in accordance with the control by the control unit (not illustrated). When the switch SW3 is switched to the ON state, the capacitor C3 and the capacitor C4 are electrically connected in parallel. In other words, in the adjustment unit 34, the capacitor C3 and the capacitor C4 are connected in parallel, and the capacitor C1 is serially connected to the capacitor C3 and to the capacitor C4. In this case, the adjustment unit 34 can change the reactance in the equivalent circuit by way of the total capacity of the capacitor C1, the capacitor C3, the capacitor C4 and the variable capacitance diode D1, as well as the coil L1.

On the other hand, when the switch SW3 is switched to the OFF state, the capacitor C4 is not electrically connected to the capacitor C3. In other words, in the adjustment unit 34, the capacitor C1 and the capacitor C3 are serially connected. In this case, the adjustment unit 34 can change the reactance in the equivalent circuit by way of the total capacity of the capacitor C1, the capacitor C3 and the variable capacitance diode D1, as well as the coil L1.

According to such a configuration, by switching the switch SW3 to any one of the ON state or the OFF state, the adjustment unit 34 can adjust the reactance in the equivalent circuit, and can more preferably perform adjustment of the resonance frequency of the antenna.

The cellular telephone device 1 of the fifth embodiment functions as a dipole antenna in the opened state, and as an inverted F antenna in the closed state. In other words, the first conductive portion 31 and the second conductive portion 33 function as an inverted F antenna only in the closed state of the cellular telephone device 1. Therefore, the cellular telephone device 1 can easily be made multiband-compatible by adjusting the reactance and adjusting the resonance frequency by way of the adjustment unit 34.

Although the preferable embodiments have been described above, the present invention is not limited to the aforementioned embodiments, and can be implemented as various embodiments. For example, although the configurations shown in FIGS. 17A to 17D have been described as configurations of the adjustment unit 34 for adjusting the reactance, the present invention is not limited thereto, and any configuration other than the circuit configurations shown in FIGS. 17A to 17D may be employed as long as such a configuration can adjust reactance.

Although the cellular telephone device 1 has been described in the above embodiments, the present invention is not limited to a cellular telephone device, and may be applied to, for example, a mobile terminal device such as a PHS (Personal Handyphone System), a PDA (Personal Digital Assistant), a portable navigation device, a notebook PC or the like.

### EXPLANATION OF REFERENCE NUMERALS

1 cellular telephone device (mobile terminal device)
2 operation unit side body (first body)
3 display unit side body (second body)
4 connecting portion
31 first conductive portion
32 circuit unit
35 ground unit
36 power feed unit
37 signal processing unit
400 second conductive portion
41, 41A first portion
42 second portion
43 switch
44 control unit
45 opening-and-closing sensor
47 slit

1. A mobile terminal device, comprising:
a first body and a second body that are connected to be capable of transitioning between an opened state and a closed state;
a detecting unit that is configured to detect the opened state and the closed state;
a circuit unit that is disposed in one of the first body or the second body, and includes a ground unit, a power feed unit, and a signal processing unit connected to the ground unit and the power feed unit;
a first conductive portion that is disposed in the first body, and is connected to one of the ground unit or the power feed unit of the circuit unit;
a second conductive portion that is disposed in the second body, is connected to the other one of the ground unit or the power feed unit of the circuit unit, and includes a first portion and a second portion that are disposed adjacently to each other in an alignment direction of the first conductive portion and the second conductive portion in the opened state; and
a control unit that cuts off the second portion from the first portion at high frequency in a case in which the detecting unit detects the closed state, and couples the first portion and the second portion at high frequency in a case in which the detecting unit detects the opened state.

2. The mobile terminal device according to claim 1, wherein the control unit cuts off the second portion from the first portion at high frequency, or connects the first portion and the second portion at high frequency, such that a high-frequency transmission path length in the first portion in the closed state is different from a high-frequency transmission path length in the first portion and the second portion in the opened state.

3. The mobile terminal device according to claim 2, further comprising a display unit that is exposed to an outside in the opened state, and is concealed by the first body or the second body in the closed state,
wherein the high-frequency transmission path length in the first portion is a length corresponding to a high-frequency frequency band that is used for exercising a communication function that does not use the display unit, and
wherein the high-frequency transmission path length in the first portion and the second portion is a length corresponding to a high-frequency frequency band that is used for exercising a communication function that uses the display unit.

4. The mobile terminal device according to claim 2, wherein, in a case in which a predetermined function is being executed in the closed state by using a high frequency transmitted to the first portion, the control unit connects the first portion and the second portion when the opened state is detected by the detecting unit and an operation of the predetermined function is suppressed.

5. The mobile terminal device according to claim 2, wherein, in a case in which a predetermined function is being executed in the opened state by using a high frequency transmitted to the first portion and the second portion, the control unit cuts off the first portion and the second portion when the closed state is detected by the detecting unit and an operation of the predetermined function is suppressed in the closed state.

6. The mobile terminal device according to claim 1,
wherein slits are formed in the first portion, and
wherein a high-frequency transmission path length formed by the slits in the first portion is substantially identical to a length of the first conductive portion in the alignment direction.

7. A mobile terminal device, comprising:
a first body and a second body that are connected to be capable of transitioning between an opened state and a closed state;
a circuit unit that is disposed in one of the first body or the second body, and includes a ground unit, a power feed unit, and a signal processing unit connected to the ground unit and the power feed unit;
a first conductive portion that is provided in the first body, and is connected to the ground unit of the circuit unit; and
a second conductive portion that is provided in the second body, is capacitively coupled to the first conductive portion, and is connected to the power feed unit of the circuit unit.

8. The mobile terminal device according to claim 7, further comprising a capacitive coupling portion that is disposed in at least one of the first body and the second body, and capacitively couples the first conductive portion and the second conductive portion in the closed state.

9. The mobile terminal device according to claim 8, wherein the capacitive coupling portion is configured to include an inductive member having inductivity.

10. The mobile terminal device according to claim 8,
wherein at least one of the first conductive portion and the second conductive portion is a circuit board on which an electronic component is mounted, and
wherein the capacitive coupling portion is the electronic component.

11. The mobile terminal device according to claim 7,
wherein the second conductive portion includes:
a first portion;
a second portion; and
a first selection unit that selects one of a first state in which the first portion and the second portion are connected, and a second state in which the first portion and the second portion are separated.

12. The mobile terminal device according to claim 7,
wherein the second conductive portion includes a first portion and a second portion that are separated at high frequency, and
wherein the mobile terminal device further includes a second selection unit that selects one of a first connection state in which the first portion and the power feed unit are connected, and a second connection state in which the second portion and the power feed unit are connected.

13. The mobile terminal device according to claim 7, wherein the circuit unit further includes an adjustment unit that is electrically connected to the signal processing unit, and in a case in which the first body and the second body move into the closed state and the first conductive portion and the second conductive portion are capacitively coupled, the adjustment unit performs adjustment of reactance including electrostatic capacity arising between the first conductive portion and the second conductive portion.

14. The mobile terminal device according to claim 13, wherein the adjustment unit further includes a third selection unit for selectively performing the adjustment of reactance.
